(19) United States
(12) Patent Application Publication
(10) Pub. No.: US 2004/0172161 A1
(43) Pub. Date: Sep. 2, 2004

(54) Vending machine and portable recording medium having recorded therein operation data transfer program for vending machine

(75) Inventors: Hideki Sadakata, Isesaki-shi (JP); Hiroshi Kudose, Sawa-gun (JP); Takayuki Akuzawa, Gunma-gun (JP)

Correspondence Address: BANNER & WITCOFF, 1001 G STREET N W, SUITE 1100, WASHINGTON, DC, 20001, US

(73) Assignee: Sanden Corporation, Isesaki-shi (JP)

(21) Appl. No.: 10/787,162

(22) Filed: Feb. 27, 2004

(30) Foreign Application Priority Data
Feb. 27, 2003 (JP) 2003-51440

(51) Int. Cl. G06F 7/00; G06F 9/00; G07F 9/08; G06F 19/00; G06F 17/00

(52) U.S. Cl. 700/236

(57) ABSTRACT

By executing operation data transfer program, which is recorded in advance in a memory card mounted to an interface of a controller, operation data stored in a second memory is recorded in a data area of the memory card, or operation data recorded in the data area of the memory card is recorded in the second memory.

### BACKGROUND OF THE INVENTION

1. Field of the Invention

The present invention relates to a vending machine having various operation data such as sales data recorded and maintained therein.

2. Description of the Related Art

Conventionally, a vending machine of this type has a controller including a storage, which stores various data to be used for operation of the vending machine such as sales data and product price data, a control program, and the like, and a central processing unit, which executes the control program. The vending machine operates by executing the control program. In addition, a remote controller for an administrator is attached to the controller, and various setting can be performed using this remote controller.

After a vending machine is put on the market, the installation site thereof may be moved, the model thereof may be changed, the function thereof may be improved, or products to be sold may be changed. In this case, the administrator of the vending machine may wish to continue to use all or a part of operation data which have previously been used. In particular, in a vending machine of a beverage extraction type, since a large number of preparation data such as an amount of hot water and temperature are required as operation data, it is necessary to, every time materials or the like for a product are changed, continuously use the operation data for other products than that for which materials or the like are changed.

As a simplest method of inheriting all or a part of such operation data, the administrator operates the remote controller attached to the controller to input previous data again. However, this operation is complicated and requires long time and, moreover, tends to cause an error in inputting data.

Thus, in the conventional vending machine, a device for the administrator called a data loader is connected to the controller, and the administrator extracts and writes operation data using this data loader in order to solve the above problem. The data loader is not provided permanently in the vending machine but is carried by the administrator. Usually, the data loader consists of a general-purpose terminal of a relatively large size provided with a liquid crystal display and a keyboard. The operation data are extracted and written by connecting the data loader to the controller and operating the keyboard.

However, data transfer with the data loader has difficulties in that it lacks portability because of the liquid crystal display and the keyboard provided therein and, moreover, key operation is complicated because the general-purpose terminal is used.

### BRIEF SUMMARY OF THE INVENTION

It is an object of the present invention to provide a portable recording medium having operation data transfer program for automatic sales and a vending machine recorded therein, with which transfer of operation data is easy.

In order to attain this object, the present invention provides a vending machine including a controller having an interface to which a portable recording medium is detachably mountable, a storage having operation data stored therein, and a central processing unit, characterized in that the central processing unit executes operation data transfer program, which is stored in advance in the portable recording medium mounted to the interface, to thereby transfer the operation data from the storage to the portable recording medium or transfer the operation data from the portable recording medium to the storage.

According to the present invention, since the portable recording medium having the operation data transfer program recorded therein is mounted to the interface of the controller, the operation data stored in the storage can be saved in the portable recording medium or the operation data stored in the portable recording medium can be written back to the storage. In other words, since an administrator is not required to carry a data loader as in the past and only has to carry the portable recording medium, which is compact and easy to carry, data transfer can be carried out readily.

Other objects, constitutions, and effects of the present invention will be evident in the following detailed description.

### BRIEF DESCRIPTION OF THE SEVERAL VIEWS OF THE DRAWINGS

FIG. 1 is a schematic block diagram of a controller of a vending machine;

FIG. 2 is a flowchart explaining an operation of the vending machine at the time of operation data transfer; and

FIG. 3 is a flowchart explaining an operation of the vending machine at the time of operation data transfer.

### DETAILED DESCRIPTION OF THE INVENTION

(First Embodiment)

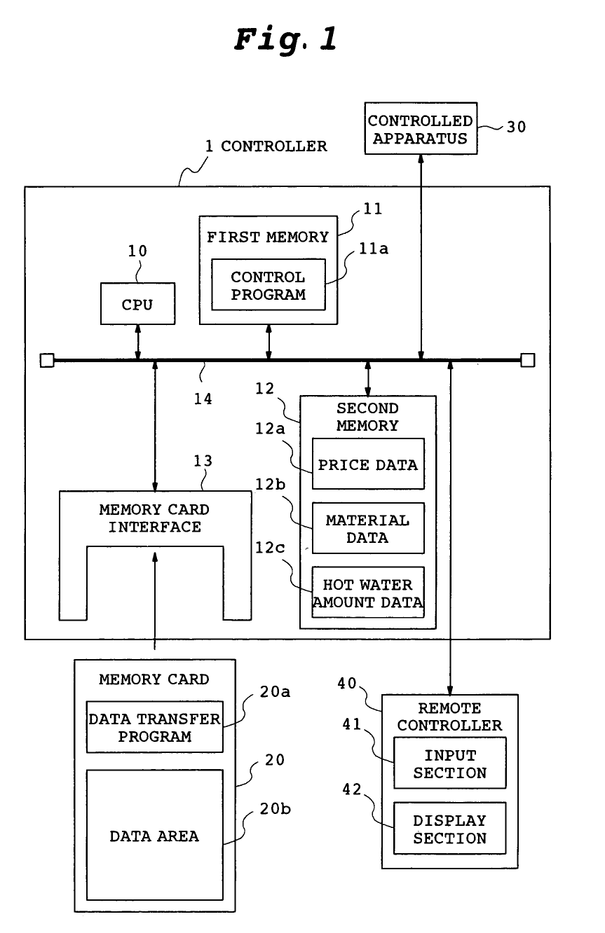

A vending machine in accordance with a first embodiment of the present invention will be described with reference to the accompanying drawings. FIG. 1 is a schematic block diagram of a controller of the vending machine. In this embodiment, description will be made of a vending machine of a beverage extraction type, which extracts regular coffee from material powder into a cup and sells the regular coffee.

As shown in FIG. 1, the controller 1 includes: a CPU (central processing unit) 10; a first memory 11 which consists of an electrically rewritable nonvolatile memory such as an EEPROM; a second memory 12 which consists of an electrically rewritable volatile memory such as an SRAM; an interface 13 to which a memory card 20 to be described later is detachably mountable; and a bus 14 which connects these devices.

The CPU 10 executes a control program 11a stored in the first memory 11, whereby the controller 1 controls a controlled apparatus 30 such as a humidifier and a beverage extraction apparatus. Various operation data are stored in the second memory 12 at the time of a control operation according to the control program 11a. In addition, the control program 11a includes a function for various kinds of management by an administrator using a remote controller 40 to be described later.

In the second memory 12, a storage area is partitioned by a plurality of (three in the example of FIG. 1) memory blocks, and the operation data are stored in the respective areas for each type, application, and the like. Examples of the operation data include sales data, a sales price, a material, an amount of hot water, extraction timing, and temperature. In the example of FIG. 1, price data 12a, material data 12b, and hot water amount data 12c are stored in the respective blocks in the second memory 12. The second memory 12 is backed up by a battery or the like and maintains contents thereof even if power supply to the vending machine is stopped.

The interface 13 is a card slot, to which the memory card 20 to be described later is detachably mountable, and is capable of notifying the CPU 10 that the memory card 20 is mounted or detached. In a state in which the memory card 20 is mounted to the interface 13, the memory card 20 is connected to the CPU 10 by a bus, and the CPU 10 can directly access a memory space in the memory card 20.

The remote controller 40 for an administrator is connected to the controller 1. The remote controller 40 includes an input section 41 consisting of buttons for inputting various instructions from the administrator and a display section 42 such as a liquid crystal display.

The memory card 20 consists of a recording medium in a card form provided with an electrically rewritable nonvolatile memory such as an EEPROM. The memory card 20 includes an operation data transfer program 20a and a data area 20b which is used by the operation data transfer program 20a. The operation data transfer program 20a consists of an extracting program, which transfers the various operation data stored in the second memory 12 of the controller 1, to the data area 20b of the memory card 20, and a writing program, which transfers the various operation data stored in the data area 20b of the memory card 20, to the second memory 12 of the controller 1. Here, the operation data transfer program 20a is executed according to an input instruction from the input section 41 of the remote controller 40 as described later.

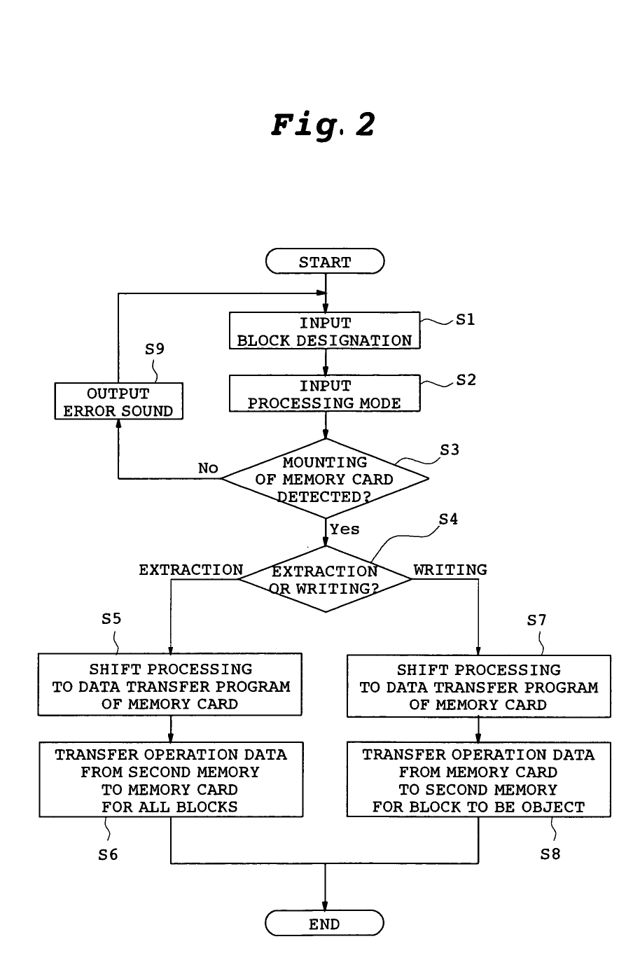

The operation of the vending machine at the time of the operation data transfer will be hereinafter described with reference to a flowchart of FIG. 2. FIG. 2 is a flowchart describing the operation of the vending machine at the time of the operation data transfer.

When a block of the second memory 12 to be subjected to transfer is designated from the input section 41 of the remote controller 40 (step S1) and a processing mode of extraction of operation data (transfer of operation data from the controller to the memory card) or writing of operation data (transfer of operation data from the memory card to the controller) is designated from the input section 41 (step S2), the controller 1 confirms whether or not the memory card 20 is mounted to the interface 13 (step S3). If the memory card 20 is not mounted, the controller 1 generates an error sound using a buzzer (not shown) attached to the controller 1 (step S9). Note that, in this embodiment, if the processing mode is extraction, designation of a block in step S1 is unnecessary.

If the processing mode in step S2 is extraction of operation data (step S4), the controller 1 shifts the processing to an extracting program of the data transfer program 20a of the memory card 20 (step S5). Then, the data transfer program 20a writes out the operation data 12a, 12b, and 12c recorded in all the blocks of the second memory 12 to the data area 20b of the memory card 20 for each block and ends the processing (step S6).

On the other hand, if the processing mode is writing of operation data (step S4), the controller 1 shifts the processing to a writing program of the data transfer program 20a of the memory card 20 (step S7). Then, for the block designated in step S1, the data transfer program 20a transfers operation data to a corresponding block of the second memory 12 of the controller 1 from the data area 20b of the memory card 20 and ends the processing (step S8).

As described above, according to the vending machine in accordance with this embodiment, the administrator can perform extraction or writing of operation data simply by mounting the memory card 20 to the interface 13 of the controller 1. Thus, the administrator can carry out transfer work of the operation data easily without carrying a large data loader around as in the past. In addition, in writing the operation data in the controller 1 from the memory card 20, the fact that only a part of the operation data can be selected and written provides for flexible transfer work. In particular, in this embodiment, all the operation data is extracted at once when the operation data is extracted from the controller 1 to the memory card 20. Thus, the present invention is preferable in terms of reusability of data in the case in which, for example, operation data of one vending machine is transferred to a plurality of other vending machines.

(Second Embodiment)

A vending machine in accordance a second embodiment of the present invention will be described with reference to the accompanying drawings. Here, only differences from the first embodiment will be described, and descriptions of the same points of the constitution will be omitted.

The vending machine in accordance with this embodiment is different from that in the first embodiment in transfer procedures for operation data. In other words, the vending machine in accordance with this embodiment is different from the first embodiment in the process executed by the operation data transfer program 20a recorded in the memory card 20.

More specifically, in the first embodiment, operation data is recorded in the memory card 20 for all the blocks of the second memory 12 and, in recording operation data in the second memory 12 from the memory card 20, only operation data selected by the remote controller 40 is recorded. On the other hand, in this embodiment, operation data recorded in the second memory 12 is recorded in the memory card 20 for a block selected by the remote controller 40, and all operation data recorded in the memory card 20 are recorded in a corresponding block of the second memory 12.

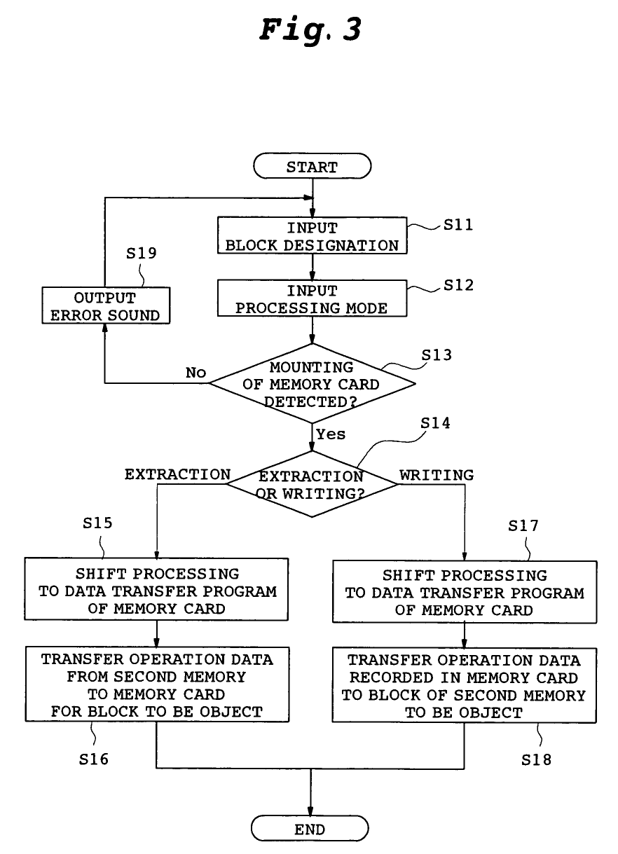

An operation of the vending machine at the time of the operation data transfer will be hereinafter described with reference to a flowchart of FIG. 3. FIG. 3 is a flowchart describing the operation of the vending machine at the time of the operation data transfer.

When a block of the second memory 12 to be an object of transfer is designated from the input section 41 of the remote controller 40 (step S111) and a processing mode of extraction of operation data (transfer of operation data from the controller to the memory card) or writing of operation data (transfer of operation data from the memory card to the controller) is designated from the input section 41 (step S12), the controller 1 confirms whether or not the memory card 20 is mounted to the interface 13 (step S13). If the memory card 20 is not mounted, the controller 1 generates an error sound using a buzzer (not shown) attached to the controller 1 (step S19). Note that, in this embodiment, if the processing mode is writing, designation of a block in step S11 is unnecessary.

If the processing mode in step S2 is extraction of operation data (step S14), the controller 1 shifts the process to an extracting program of the data transfer program 20a of the memory card 20 (step S15). Then, for the block designated in step S1, the data transfer program 20a writes out the operation data recorded in the block of the second memory 12 to the data area 20b of the memory card 20 for each block and ends the processing (step S16).

On the other hand, if the processing mode is writing of operation data (step S14), the controller 1 shifts the process to a writing program of the data transfer program 20a of the memory card 20 (step S17). Then, the data transfer program 20a transfers the operation data recorded in the data area 20b of the memory card 20 to a corresponding block of the second memory 12 of the controller 1 and ends the processing (step S18).

As described above, according to the vending machine in accordance with this embodiment, the administrator can perform extraction or writing of operation data simply by mounting the memory card 20 to the interface 13 of the controller 1. Thus, the administrator can transfer the operation data easily without carrying a large data loader around as in the past. In addition, in writing the operation data in the memory card 20 from the controller 1, the fact that only a part of the operation data can be selected and written provides for flexible transfer work. In particular, in this embodiment, only necessary operation data is extracted when the operation data is extracted from the controller 1 to the memory card 20. Thus, the present invention is preferable in that an operation in writing operation data in the controller 1 from the memory card 20 is simplified.

The two embodiments of the present invention have been described in detail. However, the present invention is not limited to these embodiments. A scope of the present invention is indicated by appended claims, and all modifications falling under meaning of the respective claims are included in the present invention.

For example, in the above-described respective embodiments, the operation data transfer program is executed immediately when the memory card is mounted. However, execution of the operation data transfer program may be started according to an instruction for execution by the administrator. The instruction for execution may be performed using a remote controller or may be performed by providing a dedicated switch or the like in the controller.

In addition, in the operation data transfer program, a model of the vending machine may be limited. More specifically, when operation data is recorded in the memory card, model information of the vending machine is recorded together with the operation data, and propriety of transfer is determined with reference to the model information of the memory card before transferring the operation data from the memory card to the controller. Consequently, an error in transfer of the operation data can be prevented.

Moreover, in the above-described embodiment, the vending machine of a beverage extraction type is described as an example of the vending machine. However, the present invention can be applied to vending machines of other forms such as a vending machine for canned beverage.

We claim:

1. A vending machine comprising a controller having an interface to which a portable recording medium is detachably mountable, a storage having operation data stored therein, and a central processing unit,
wherein said central processing unit executes operation data transfer program, which is stored in advance in said portable recording medium mounted to said interface, to thereby transfer the operation data from said storage to said portable recording medium or transfer the operation data from said portable recording medium to said storage.

2. The vending machine according to claim 1, further comprising a remote controller to be connected to said controller,
wherein the operation data is stored in a plurality of memory blocks of said storage, and
said controller performs transferring of the operation data for each memory block designated by said remote controller.

3. The vending machine according to claim 1, further comprising a remote controller to be connected to said controller,
wherein said operation data transfer program includes an extracting program for transferring the operation data from said storage to said portable recording medium and a writing program for transferring the operation data from said portable recording medium to said storage, and
said controller executes said extracting program or said writing program according to a processing mode designated by said remote controller.

4. A portable recording medium having recorded therein an operation data transfer program which causes a vending machine comprising a controller having an interface to which a portable recording medium is detachably mountable, a storage having operation data stored therein, and a central processing unit to function as means for transferring operation data from said storage to said portable recording medium or transferring the operation data from said portable recording medium to said storage.
